(19) United States
(12) Patent Application Publication
(10) Pub. No.: US 2008/0115843 A1
(43) Pub. Date: May 22, 2008

(54) Negative check valve of a pneumatic transfer pipe

(76) Inventor: Chi-Chang Wang, Taipei Hsien (TW)

Correspondence Address: CHI-CHANG WANG, 235 Chung-Ho, Box 8-24, Taipei, omitted

(21) Appl. No.: 11/601,829

(22) Filed: Nov. 20, 2006

(51) Int. Cl. F16K 15/00

(52) U.S. Cl. 137/533.17

(57) ABSTRACT

A negative check valve of a pneumatic transfer pipe comprises a casing having a hollow chamber and a channel which is communicated to the hollow chamber; a cover having a penetrating channel; a plug movably received in the hollow chamber of the casing; a washer installed between the casing and the cover; an center of the washer having an opening which can be sealed by the plug; wherein when a positive pressure is applied to the plug, the plug will be pushed upwards by floating force and the pressure so as to seal the opening of the washer to isolate the opening. When a negative pressure is applied to the plug by suction force of vacuum, the plug will descend to the bottom of the hollow chamber so that the opening is opened and gas or liquid flows through the washer.

### FIELD OF THE INVENTION

The present invention relates to negative pressure check valve, and particularly to a negative check valve of a pneumatic transfer pipe which is widely used in the oil saving/water system of fuel pipes of vehicles and transferring pipes of water and chemical liquids.

### BACKGROUND OF THE INVENTION

A prior art check valve has a steel ball and a spring. Positive pressure is used to shift the steel ball so as to opening the valve for providing air or liquid. When the positive pressure is disappear, the steel ball moves and the spring extends so that the steel ball returns to the original position to close the check valve.

However this prior art design is not suitable for negative pressures. Thus o until now, no negative pressure check valve is provided.

However in many current applications, such as oil or water saving pipes by using Venturi tubes, the negative pressure check valve is required in conditions so as to have preferred effects.

### SUMMARY OF THE INVENTION

Accordingly, the primary object of the present invention is to provide a negative check valve of a pneumatic transfer pipe, which is widely in used the oil saving/water system of fuel pipes of vehicles and transferring pipes of water and chemical liquids.

To achieve above objects, the present invention provides a negative check valve of a pneumatic transfer pipe which comprises a casing having a hollow chamber and a channel which is communicated to the hollow chamber; a cover having a penetrating channel; a plug movably received in the hollow chamber of the casing; a washer installed between the casing and the cover; an center of the washer having an opening which can be sealed by the plug; wherein when a positive pressure is applied to the plug, the plug will be pushed upwards by floating force and the pressure so that seal the opening of the washer to isolate the opening; when a negative pressure is applied to the plug by suction force of vacuum, the plug will descend to the bottom of the hollow chamber so that the opening is opened and gas or liquid flows through the washer.

The various objects and advantages of the present invention will be more readily understood from the following detailed description when read in conjunction with the appended drawing.

### BRIEF DESCRIPTION OF THE DRAWINGS

FIG. 1 is an assembled schematic view of the present invention.

FIG. 2 is an assembled schematic view of the present invention.

FIG. 3 is a cross sectional view along line 3-3 of FIG. 2.

FIG. 4 is a cross sectional view along line 4-4 of FIG. 3.

FIG. 5 is a schematic view showing that the plug of the present invention is closed.

FIG. 6 shows one application of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

The negative check valve of a pneumatic transfer pipe of the present invention is widely used in the oil saving/water system of fuel pipes of vehicles and transferring pipes of water and chemical liquids.

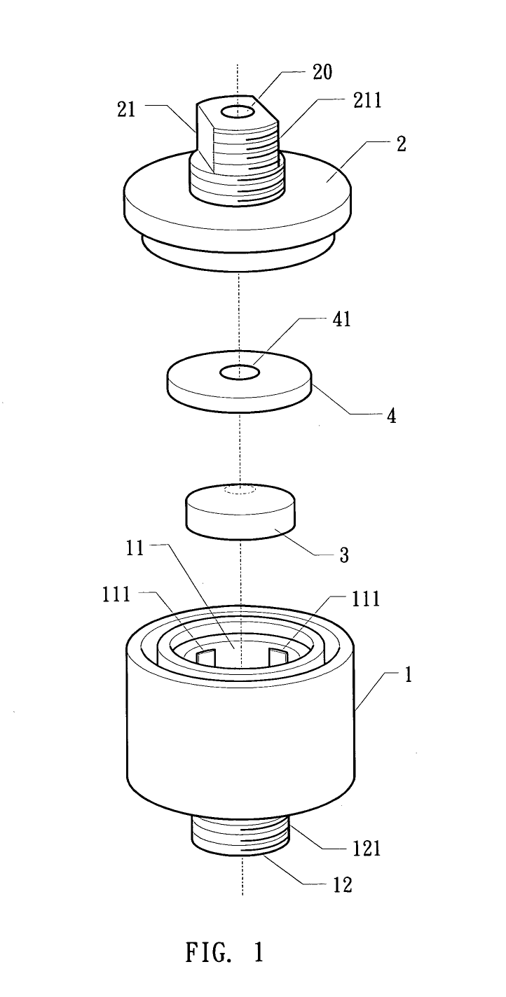

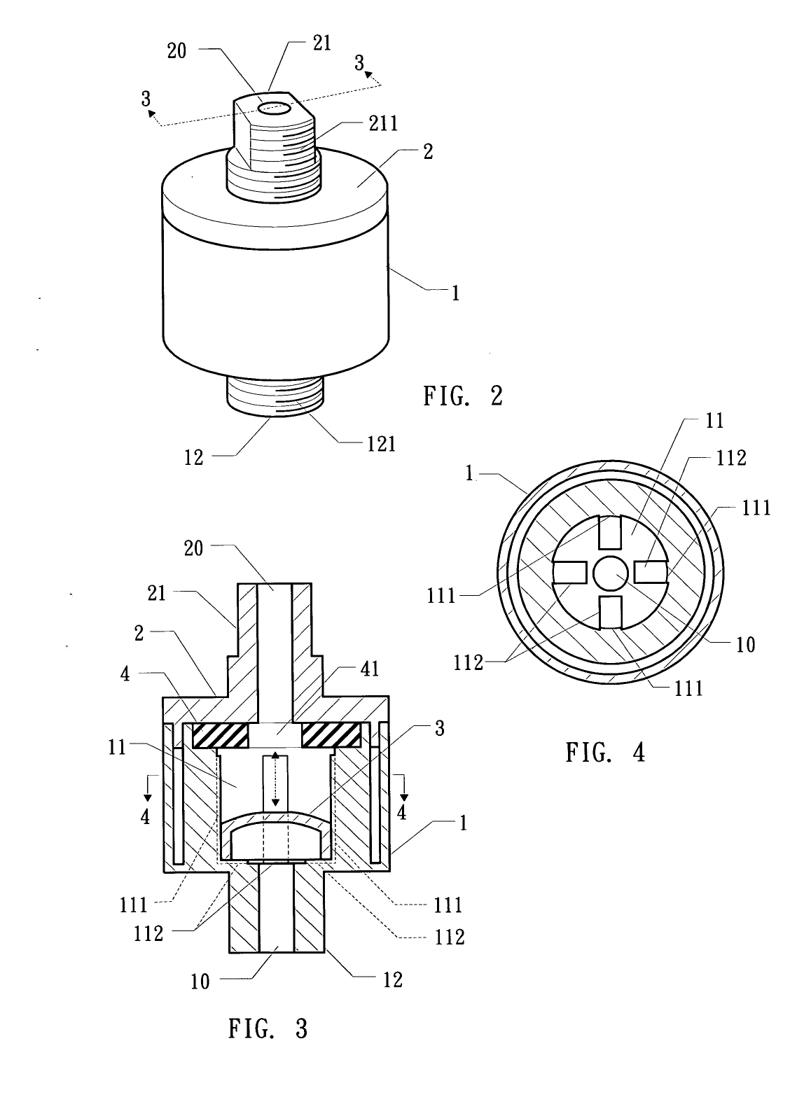

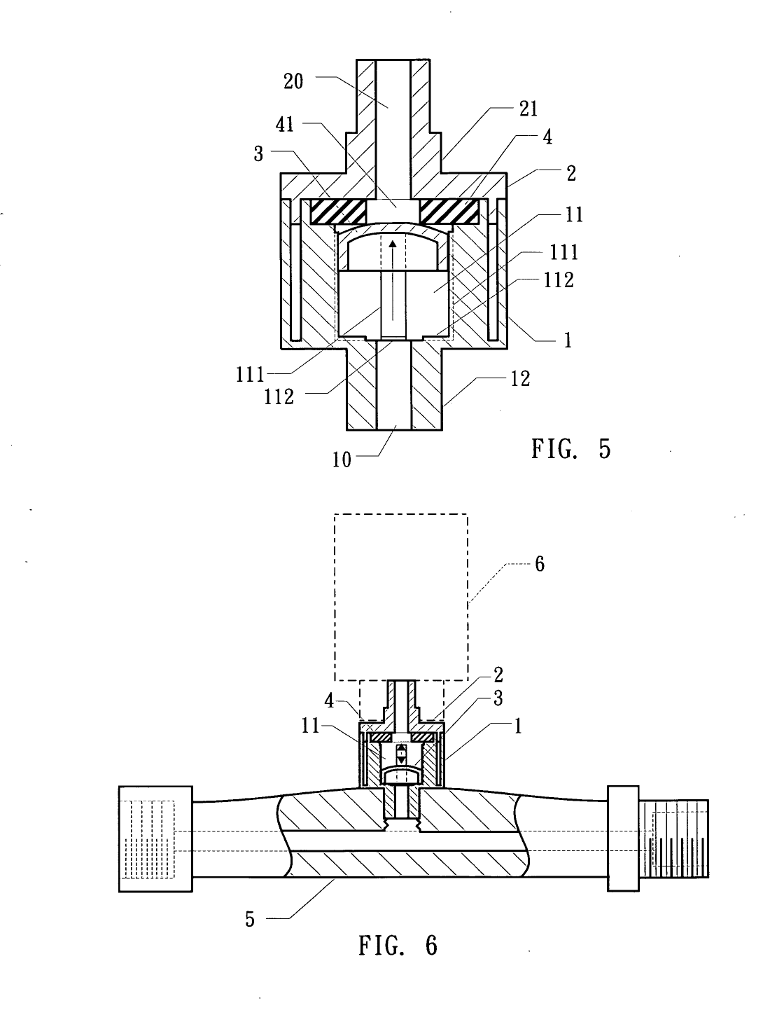

Referring to FIGS. 1 to 3 of the present invention, the valve body of the present invention includes the following elements.

A casing 1 has a hollow chamber 11 and a channel 10 which is communicated to the hollow chamber 11. The casing 1 has a joint 12 with outer thread 121 for engaging with other pipes or a Venturi tube n (referring to FIG. 6). An inner wall of the hollow chamber 11 has a plurality of guide strips 111 for retaining the plug 3 to move within the chamber 11 steadily. A bottom of the hollow chamber 11 has a plurality of protrusions 112 for flowing liquid.

A cover 2 has a penetrating channel 20 and a joint 21 with outer thread 211 for engaging with another pipe or gas/liquid filter 6.

A plug 3 is movably received in the hollow chamber 11 of the casing 1. A bottom of the plug 3 has a concave or plan bottom.

A washer 4 is installed between the casing 1 and the cover 2. A center of the washer 4 has an opening 41 which can be sealed by the plug 3.

Referring to FIG. 6, the application of the present invention is illustrated. When a positive pressure is applied to the plug 3, the plug 3 will be pushed upwards by floating force and the pressure so as to seal the opening 41 of the washer 44 to isolate the opening 41. When a negative pressure is applied to the plug 3 by suction force of vacuum, the plug 3 will descend to the bottom of the hollow chamber 11 so that the opening 41 is opened and gas or liquid flows through the washer 44. Thus the operation of the present invention is smoothly and structure is simple.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A negative check valve of a pneumatic transfer pipe comprising:
a casing having a hollow chamber and a channel which is communicated to the hollow chamber;
a cover having a penetrating channel;
a plug movably received in the hollow chamber of the casing;
a washer installed between the casing and the cover; an center of the washer having an opening which can be sealed by the plug;
wherein when a positive pressure is applied to the plug, the plug will be pushed upwards by floating force and the pressure so that seal the opening of the washer to isolate the opening; when a negative pressure is applied to the plug by suction force of vacuum, the plug will descend to the bottom of the hollow chamber so that the opening is opened and gas or liquid flows through the washer.

2. The negative check valve of a pneumatic transfer pipe as claimed in claim 1, wherein a cover has a penetrating channel and a joint with outer thread for engaging with another pipe or gas/a liquid filter.

3. The negative check valve of a pneumatic transfer pipe as claimed in claim 1, wherein the casing has a joint with outer thread for engaging with other pipes or a Venturi tube.

4. The negative check valve of a pneumatic transfer pipe as claimed in claim 1, wherein an inner wall of the hollow chamber has a plurality of guide strips for retaining the plug to move within the chamber steadily and a bottom of the hollow chamber has a plurality of protrusions for flowing liquid.

5. The negative check valve of a pneumatic transfer pipe as claimed in claim 1, wherein a bottom of the plug has a concave or plan bottom.
